(19) United States
(12) Patent Application Publication
(10) Pub. No.: US 2010/0273138 A1
(43) Pub. Date: Oct. 28, 2010

(54) APPARATUS AND METHOD FOR AUTOMATIC GENERATION OF PERSONALIZED LEARNING AND DIAGNOSTIC EXERCISES

(76) Inventors: Philip Glenny EDMONDS, Oxford (GB); Anthony HULL, Oxford (GB); Patrick Rene TSCHORN, Oxford (GB)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/431,294

(22) Filed: Apr. 28, 2009

(51) Int. Cl. G09B 3/00; G09B 7/00

(52) U.S. Cl. 434/322

(57) ABSTRACT

A computer-implemented method for automatically generating learning exercises, including determining a target learning item in response to an event, obtaining a knowledge level of a learner in relation to the target learning item based on a model of the learner as produced by an automated learner model, associating a level of difficulty with the obtained knowledge level of the learner, retrieving a learning exercise pattern from an exercise pattern database, automatically generating a learning exercise relating to the retrieved learning exercise pattern based on the model of the learner and the associated level of difficulty; and presenting the learning exercise to the learner via an exercise interface.

### BACKGROUND OF THE INVENTION

i. Field of the Invention

The present invention relates to a computer-implemented learning method and apparatus.

ii. Description of Related Art

Educators need a large range of learning exercises for their students. Such exercises are used to teach new material, to help support learning in a student, to assess if learning is occurring, to assess level of ability, and to diagnose problems in learning.

Examples of simple exercises include multiple choice questions, true/false questions, matching questions, fill-in-the-blank questions, and open-ended questions

Learning exercises are expensive and time-consuming for educators to create so automated methods are an attractive solution. One class of solutions to this problem uses authoring tools to help educators create questions. Authoring tools are disclosed in patents U.S. Pat. No. 6,018,617, U.S. Pat. No. 6,704,741, U.S. Pat. No. 6,259,890, and others. Another class of solutions assembles or generates a computer-based test from a database of exercises that could have been created through other means (e.g., an authoring tool or automatic means). Such computer-based testing systems are disclosed in GB237362B, U.S. Pat. No. 5,565,316, US2004234936A, and others.

Another class of solutions is to create exercises completely automatically. There are many methods for automatically creating learning activities from textual content, that is, from textbooks, novels, or other reading material. Methods are described by Brown et al. (Automatic Question Generation for Vocabulary Assessment, Proc. of the Conf. on Human Language Technology, 2005), Mostow et al. (Using Automated Questions to Assess Reading Comprehension, Cognition and Learning Vol. 2, 2004), Coniam (A Preliminary Inquiry Into Using Corpus Word Frequency Data in the Automatic Generation of English Language Cloze Tests, CALICO Journal Vol. 14 Nos. 2-4, 1997), Aist (Towards Automatic Glossarization, Int. J. of Artificial Intelligence in Education Vol. 12, 2001), Hoshino and Nakagawa (A Real-Time Multiple-Choice Generation for Language Testing, Proc. of the 2nd workshop on Building Educational Applications using NLP, 2005), Sumita et al. (Measuring Non-Native Speakers' Proficiency of English Using a Test with Automatically-Generated Fill-In-The-Blank Questions, Proc. of the 2nd Workshop on Building Educational Applications using NLP, 2005), Mitkov and Ha (Computer-Aided Generation of Multiple-Choice Tests, Proc. of the Workshop on Building Educational Applications using NLP, 2003), and in inventions as disclosed in U.S. Pat. No. 6,341,959, JP26126242A, JP27094055A2).

The above methods take a target word or concept as input and then use a two step process that selects first a question ‘stem’ and second the correct answer and its ‘distractors’ (i.e., the different possible incorrect answers to choose from), each depending on the type of exercise required. The target word or concept can appear in the stem or as the correct answer. In one example, to create a multiple-choice exercise to test if a student knows the meaning of a word, the stem is the dictionary definition of the target word, and the distractors are words chosen from a database or the reading text whose meanings are different from the target word. In a second example, a fill-in-the-blank question can be created by first selecting a sentence from the reading text that contains the target word or concept and replacing the word or concept with a blank. The distractors are chosen in a similar fashion to the first example, and the target word is included as a possible answer option. In a third example, a comprehension exercise can be generated by selecting a sentence from the reading text that contains the target word or concept and restructuring the sentence into a question (for example, the sentence “The earth revolves around the sun” can be restructured as “What does the earth revolve around?”).

It has been shown in the above referenced works that automatically generated exercises are effective for learning and low-stakes assessment, however one problem is to set the right level of difficulty for a particular student. If exercises are too easy for a student, then boredom sets in and no learning occurs. If exercises are too difficult, they can be de-motivating, resulting in unwanted behaviours such as excessive guessing.

Some of the automatic methods can vary the level of difficulty by changing certain parameters. For example, Nagy et al. (Learning Words From Context, Reading Research Quarterly Vol. 20, 1985) vary the difficulty of an exercise by varying the closeness of the distractors to the correct answer on three levels: 1) distractors with a different part of speech than the correct answer (easy); 2) distractors with the same part-of-speech, but a different semantic class than the correct answer (medium); and 3) distractors that have similar meanings to the correct answer (difficult). Mostow et al. (Using Automated Questions to Assess Reading Comprehension, Cognition and Learning Vol. 2, 2004), and Aist (Towards Automatic Glossarization, Int. J. of Artificial Intelligence in Education Vol. 12, 2001), and others, use additional means including varying the familiarity of the distractors (in this work, familiarity is conceived of as an intrinsic property of a word correlated to its frequency in general language; it does not refer to student-dependent familiarity) and varying the difficulty of the question stem.

However, none of the methods above for automatic creation of exercises controls the level of difficulty depending on the ability of a particular student for whom the exercise is generated. Exercises either have a predetermined level of difficulty, or worse an unpredictable level depending on the random selection of exercise elements. That is, no method uses a model of the user's current knowledge.

Educators can of course manually control difficulty level for individual students (using authoring tools or manual means), but it is not cost-effective to personalize exercises for each student.

One solution for controlling the difficulty depending on student ability is used in Computer Adaptive Testing (CAT) (Wainer et al., Computerized adaptive testing: A primer, Hillsdale, N.J.: Lawrence Erlbaum Associates, 1990; van der Linden & Hambleton (eds.), Handbook of Modern Item Response Theory, London: Springer Verlag, 1997). In CAT, a test item is selected for a particular student using a statistical method such that the student has a 50% chance of answering the item correctly based on a record of the student's history of responses to test items (a type of user model). This method is personalized to individual students; however, test items must be generated beforehand and calibrated by trialing each one on many real students. Thus exercises cannot be created on demand. Moreover, test items, whether generated manually or automatically will only work in the context of the CAT system in which ‘ability’ is represented as a single number representing overall ability in the subject of the test. This model of ability is appropriate for overall assessment purposes, but is not fine-grained enough to be suitable for the teaching or diagnostic purposes of exercises.

What is needed is a method to automatically generate learning exercises (for a variety of educational purposes) that are related to the subject material from which a student is learning, and that have a controlled level of difficulty depending on the ability of the student.

### SUMMARY OF THE INVENTION

An embodiment of the present invention provides a system that can automatically generate a new learning exercise for a chosen learning item in dependence on a model of a particular learner's current ability and other information.

In the preferred embodiment, a language learning device such as an electronic book reading device that includes a learner model, e.g., as is disclosed in the method and apparatus of GB0702298A0 (the entire contents of which are incorporated herein by reference), is modified to include the present system. The modified device allows a learner to select a learning item, such as a word in the book, and then do a learning exercise about the item at the right level of difficulty for the learner.

The system combines information from a fine-grained model of the learner's current knowledge, a database of exercise patterns, and an optional analysis of the current language material. Exercise difficulty is controlled by two means. First, the learner's level of ability of a word indicates how difficult an exercise should be. Greater word knowledge will lead to greater exercise difficulty. Second, the elements of the exercise itself are generated in dependence on the user model. To make an exercise more difficult, for example, it can include as distractors words that the user has not yet completely mastered; whereas, to make an easy question, already mastered words should be used. Thus, different learners (who have different abilities) will receive different exercises. For example, even if two learners have the same level of knowledge for a given word, they will receive different exercises because of their differing knowledge on other words.

In this embodiment, a learner model for a particular learner tracks for each learning item (e.g., words or vocabulary units) whether the learner has mastered the particular item and to what extent. The learner model can be updated every time the learner performs an action in the system, such as reading the word in the book, or doing a learning exercise.

An embodiment of the invention has one or more of the following advantages.

An advantage of the system is that it enables a personalized educational system that maximizes the learning effectiveness of learning exercises, since the exercises can be controlled to have the right level of difficulty.

A further advantage of the system is that it can save the expense, time, and human effort of manually creating suitable learning exercises for each learner and for each learning item in a book or other language material.

A further advantage of the system is that it can save on the storage space of the learning exercises since the exercises can be generated on demand, that is, only after a learner selects to do a learning exercise on a learning item.

A further advantage of the system is that the learning exercises can be generated and done by the learner during the task of reading or using language material, or afterwards as review, or not in association with any particular language material.

A further advantage of the system is that is can be suitable for low-stakes assessment of current learner ability.

A further advantage of the system is that it can work within any educational system that includes language material (spoken or written). Thus, the educational system can be for learning any subject matter such as for example physics or history, or indeed any domain that includes vocabulary and concepts that a learner is interested in learning.

According to one aspect of the invention, a computer-implemented method for automatically generating learning exercises is provided. The method includes determining a target learning item in response to an event, obtaining a knowledge level of a learner in relation to the target learning item based on a model of the learner as produced by an automated learner model, associating a level of difficulty with the obtained knowledge level of the learner, retrieving a learning exercise pattern from an exercise pattern database, automatically generating a learning exercise relating to the retrieved learning exercise pattern based on the model of the learner and the associated level of difficulty, and presenting the learning exercise to the learner via an exercise interface.

According to another aspect the generating of the learning exercise includes generating one or more distractors.

In accordance with another aspect, the distractors are generated based on at least one of the model of the learner and the associated level of difficulty.

In accordance with still another aspect, the distractors are retrieved from a learning item information database.

In yet another aspect, the learning exercise pattern includes a stem.

According to another aspect, the stem is selected based on at least one of the model of the learner and the associated level of difficulty.

With still another aspect, the state of the learner model changes over time to reflect a current knowledge level of the learner.

In accordance with another aspect, the target learning item is determined based on a selection of a word or group of words among text displayed on a user interface, and the knowledge level of the learner is determined by the automated learner model based on at least one of the learner's displayed mastery or familiarity with the word or group of words.

Further, according to another aspect the learning exercise is generated based in part on a linguistic analysis of the selected word or group of words.

According to yet another aspect, the exercise pattern database includes learning exercise patterns for a plurality of learning exercise types.

According to another aspect, the plurality of learning exercise types include at least one of multiple choice questions, true/false questions, matching questions, fill-in-the-blank questions, open-ended questions or comprehension questions.

In yet another aspect, the learning exercise is retrieved based on the associated level of difficulty.

In accordance with another aspect of the invention, a computer-implemented apparatus for automatically generating learning exercises is provided. The apparatus includes a section for determining a target learning item in response to an event, a section for obtaining a knowledge level of a learner in relation to the target learning item based on a model of the learner as produced by an automated learner model, a section for associating a level of difficulty with the obtained knowledge level of the learner, a section for retrieving a learning exercise pattern from an exercise pattern database, a section for automatically generating a learning exercise relating to the retrieved learning exercise pattern based on the model of the learner and the associated level of difficulty; and a section for presenting the learning exercise to the learner via an exercise interface.

According to another aspect, the section for automatically generating is operative to generate one or more distractors.

In accordance with another aspect of the apparatus, a user interface and the target learning item is determined based on a selection of a word or group of words among text displayed on the user interface, and the knowledge level of the learner is determined by the automated learner model based on at least one of the learner's displayed mastery or familiarity with the word or group of words.

According to another aspect, the learning exercise is generated based in part on a linguistic analysis of the selected word or group of words.

According to yet another aspect, the exercise pattern database includes learning exercise patterns for a plurality of learning exercise types.

Regarding another aspect, the apparatus includes a plurality of learning exercise types include at least one of multiple choice questions, true/false questions, matching questions, fill-in-the-blank questions, open-ended questions or comprehension questions.

In accordance with another aspect, the learning exercise pattern is retrieved based on the associated level of difficulty.

In accordance with another aspect of the invention, a computer program is stored on a computer-readable medium which, when executed by a computer, causes a computer to carry out the functions of determining a target learning item in response to an event, obtaining a knowledge level of a learner in relation to the target learning item based on a model of the learner as produced by an automated learner model, associating a level of difficulty with the obtained knowledge level of the learner, retrieving a learning exercise pattern from an exercise pattern database. automatically generating a learning exercise relating to the retrieved learning exercise pattern based on the model of the learner and the associated level of difficulty, and presenting the learning exercise to the learner via an exercise interface.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a block diagram of an exemplary embodiment of an educational system in accordance with the present invention.

FIG. 2 shows a page of an example text being displayed in a text-reading interface.

FIG. 3 is a flow chart of the exercise generator component in accordance with an embodiment of the present invention.

FIG. 4 is an example of a learner model in accordance with an embodiment of the present invention.

FIG. 5 shows examples of generated exercises.

FIG. 6 relates to an example of generating an exercise.

FIG. 7 is a block diagram of a computer-implemented educational system in accordance with an embodiment of the present invention.

### DETAILED DESCRIPTION OF THE INVENTION

An exemplary embodiment of the present invention can automatically generate vocabulary learning exercises at a suitable level of difficulty for a particular learner within a reading-based device for language learning and in particular vocabulary learning.

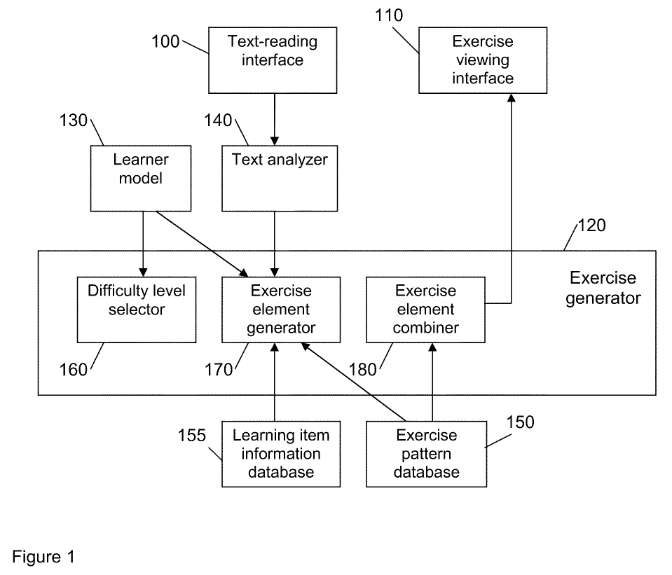

FIG. 1 is a block diagram of the components of the exemplary embodiment.

A device for language learning and in particular vocabulary learning has a text-reading interface 100. The text-reading interface displays the current text. The device contains an exercise viewing interface 110 in which the learner can view or interact with learning exercises. The device contains an exercise generator 120. The exercise generator comprises a difficulty level selector 160, an exercise element generator 170, and an exercise element combiner 180. The difficulty level selector 160 has access to a learner model 130. The exercise element generator 170 also has access to the learner model 130, to an exercise pattern database 150, and, optionally, to a learning item information database 155 and an analysis of the current text produced by the text analyzer 140. The exercise element combiner 180 has access to the exercise pattern database 150.

Those skilled in the art will appreciate that a device for language learning may include further components and that the components may communicate to each other in ways not explicitly shown in FIG. 1. Those skilled in the art will appreciate that the components illustrated in FIG. 1 may be implemented as separate components or several or all of them may be combined into a single component.

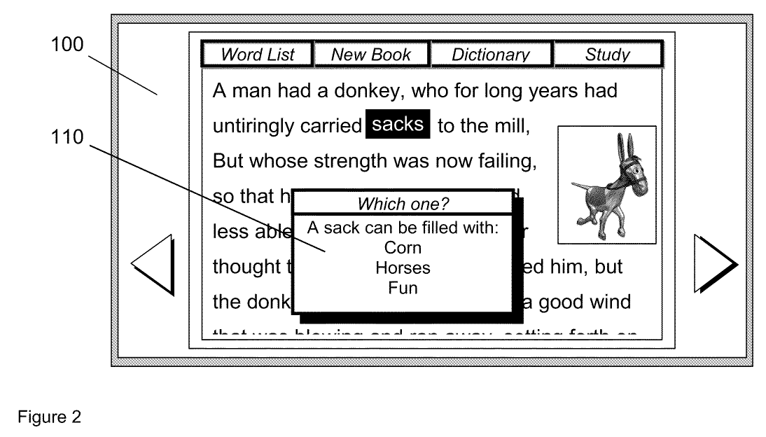

FIG. 2 shows an example of a text-reading interface 100 and an exercise viewing interface 110 that will be referred to in the proceeding text.

The function of the components shown in FIG. 1 will now be described in greater detail.

The text-reading interface 100 displays electronic text and provides user controls for a variety of possible user actions including, but not limited to, moving between pages and selecting words. In FIG. 2, for example, the word “sacks” has been selected.

The exercise viewing interface 110 displays an exercise of the type generated by the exercise generator 120. The exercise can be non-interactive, that is, only to be viewed by the learner. The exercise can be interactive, requiring controls for a variety of possible user actions including selecting an answer, entering an answer, and so on. In FIG. 2, for example, a multiple choice exercise about the word “sack” is shown.

The learner model 130 stores an estimate of a learner's degree of mastery of learning items, which, in this embodiment, are words. In this document, when we use the term “word”, we mean word, phrase, term, or any other unit of vocabulary. Learner modeling is well known in the art, and any suitable learner model can be employed in the preferred embodiment, with the proviso that it is a fine-grained learner model. In this document, by “fine-grained”, we refer to any model that can represent degree of mastery on a per learning-item basis, rather than on whole-subject basis as used in, for example, Computer Adaptive Testing.

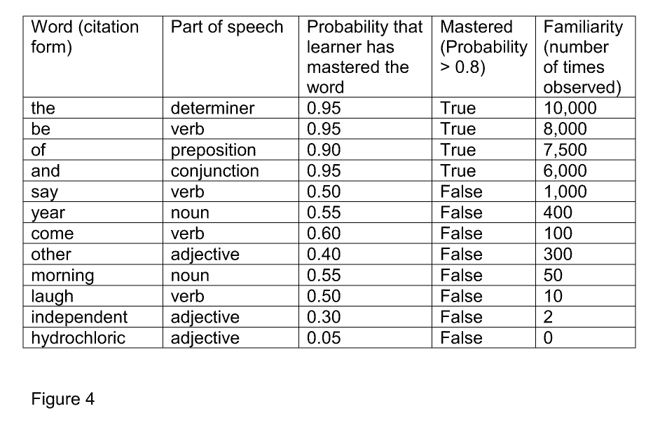

Since a learner's actual mastery of a word cannot be directly observed, conventional learner models estimate degree of mastery of particular words based on evidence gained from learner interactions with the system. In a preferred embodiment, the learner model maintains probabilities that a particular learner has mastered a particular word. Numerical values such as probabilities can be converted into discrete Boolean (i.e., True/False) values by the application of a threshold. For example, probabilities greater than 0.8 could be converted into True (i.e., the learner has mastered the word) and other probabilities into False. FIG. 4 shows an example of a learner model, represented as a table, at a certain point in time.

Optionally, the learner model can also include information about the familiarity of a word or other language construct (such a sentence) to the learner. Familiarity can be dependent on the number of times that a learner has observed the word or otherwise interacted with the word. Familiarity can decay over time if learner becomes less familiar (i.e., does not interact) with the word.

The learner model 130 can be queried by the difficulty level selector 160 and by the exercise element generator 170. Given a particular word, the learner model 130 will return the learner's estimated degree of mastery of the word and/or the learner's estimated familiarity with the word. The state of the learner model can change over time, for example, when a learner reads a word in the current text, when a learner consults a dictionary entry of the word, or when the learner explicitly demonstrates knowledge of the word by interacting with a learning exercise.

The text analyzer 140 is an optional component. It can perform a linguistic analysis of selected portions of the current text. The analysis can be used by the exercise generator 120 in order to generate certain types of exercise, for example, a gap-filling exercise in which a sentence of the current text has one word replaced by a gap that the learn must then fill in, or by a re-structuring of a sentence of the current text into a comprehension question.

The exercise pattern database 150 contains a range of exercise patterns for different types of learning exercise. Exercise patterns are well known in the art, and are often called templates. Any suitable database can be employed in the preferred embodiment. In general, a pattern has two elements: a stem and answer options. The stem represents the question and the answer options include the correct answer and one or more distractors. Answer options are optional; if they are present the learner answers by selecting one, if not, the learner must provide an answer.

Many exercise types are permissible and the range is not limited by this invention. General types include multiple choice questions, true/false questions, matching questions, fill-in-the-blank questions, open-ended questions, and comprehension questions. Specific types of question may include information about the definition or meaning of a word, grammar, translations of a word, how a word is used in a sentence, images or sounds related to a word, writing or speaking a word, or any other aspect of word knowledge.

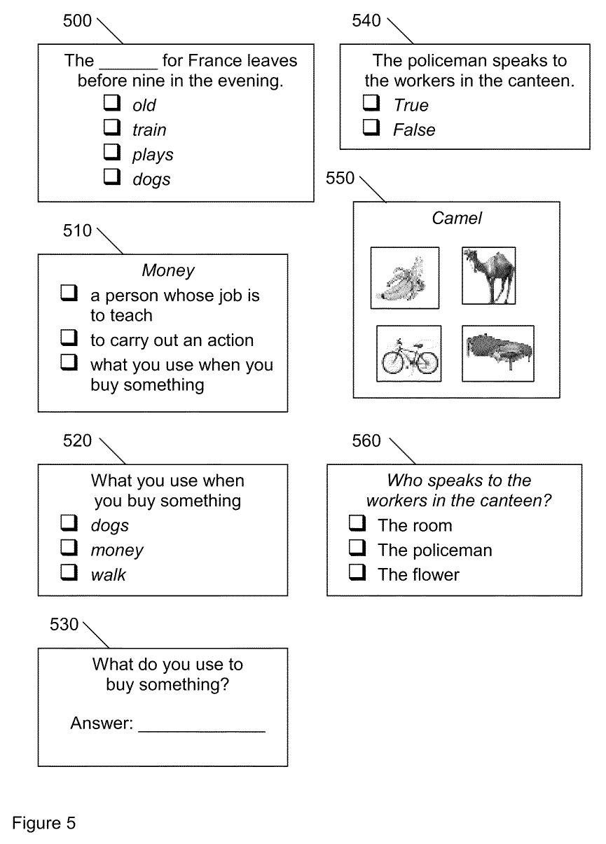

FIG. 5 shows some examples of exercises. Example 500 shows a fill-in-the-blank exercise. Example 510 shows a multiple choice question to choose the right meaning. Example 520 shows a multiple choice question to choose the word for a given meaning. Example 530 shows an open-ended question to enter the right word for the given definition. Example 540 shows a true/false question. Example 550 shows a multiple choice question to choose the right picture. Example 560 shows a comprehension question, requiring the learner to have understood the current text.

The learning item information database 155 is an optional component. Its need depends on the exercise pattern selected from the exercise pattern database 150. The learning item information database contains information about learning items that can be used in the generation of exercises. Information can include, but is not limited to, dictionary definitions, pronunciation information in written or audio forms, associated images, associated words or concepts, examples of usage, part of speech, semantic classes, translations, and synonyms.

The exercise generator 120 takes as input a selected learning item (that is, a word in the current text, in this embodiment) and a predetermined choice of exercise type. It outputs an exercise at an appropriate level of difficulty. The difficulty of an exercise can be related to two sources of information. First, difficulty can be related to the level of knowledge and familiarity the learner has of the selected learning item. If a user has almost mastered the learning item or is quite familiar with the learning item, then an appropriate difficulty level can be high. If the learner has not yet mastered the learning item, then an appropriate difficulty level can be lower. Second, difficulty can be related to the level of knowledge and familiarity that the learner has with respect to the elements of the exercise. A more difficult exercise can be generated by including words that the learner is not familiar with, for example.

In the preferred embodiment, the exercise generator 120 uses the learner model 130 in two different steps. In the first step, a suitable level of difficulty is selected in dependence on the learner model. In the second step, elements of the learning exercise are selected in dependence on the learner model 130 and, optionally, on the analysis of the language material by the text analyzer 140. The generated exercise is provided to the exercise viewing interface 110.

The difficulty level selector 160 selects an exercise difficulty level by consulting the learner model 130 to find out the current level of mastery of the selected learning item. Difficulty level can be a number in a range, for example, the range 0.0-1.0, where 0.0 represents easy and 1.0 represents difficult. Alternatively it can be selected from a set of discrete values, for example, “VERY-EASY”, “EASY”, “MEDIUM”, and “HARD”. The latter alternative is used in the preferred embodiment.

The exercise element generator 170 consults the exercise pattern database 150 to find out which elements are required for the predetermined exercise type. Then, it automatically generates the required elements. In doing so it consults the learner model 130 in order to generate a stem and distractors at the right level for the learner. This process is described in detail below.

The exercise element combiner 180 uses the exercise pattern from the exercise pattern database 150 to combine the elements into an exercise in the prescribed way.

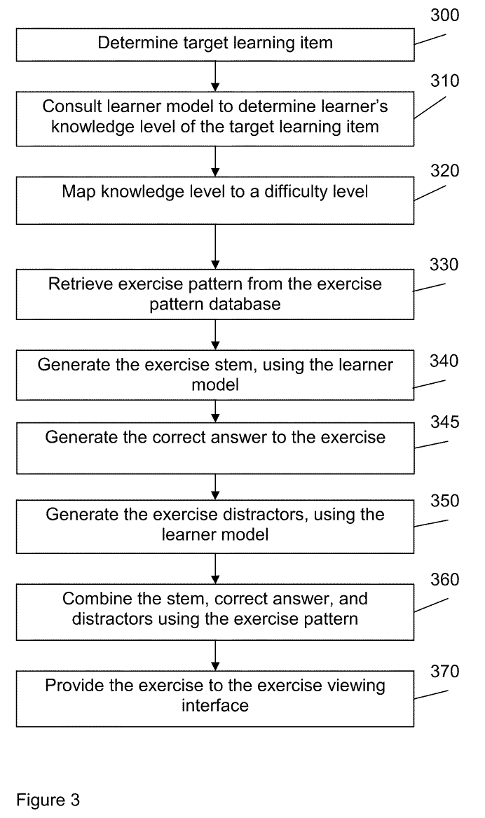

FIG. 3 is a flow chart of the exercise generation process performed by component 120.

The exercise generation process is started when an event occurs in the system. Any type of event can be used as a trigger, for example, the learner selecting a word in the current text, or the learner selecting a menu option to do an exercise or a review, or the system requesting an exercise to be generated, for example as part of a separate process to generate exercises for a set of words.

The first step 300 receives the “start” event and then determines the target learning item in the current context. In the preferred embodiment this is the word that has been selected by the user in the text-reading interface 100.

The second step 310 is to obtain the learner's level of word knowledge and word familiarity from the learner model 110 for the target learning item.

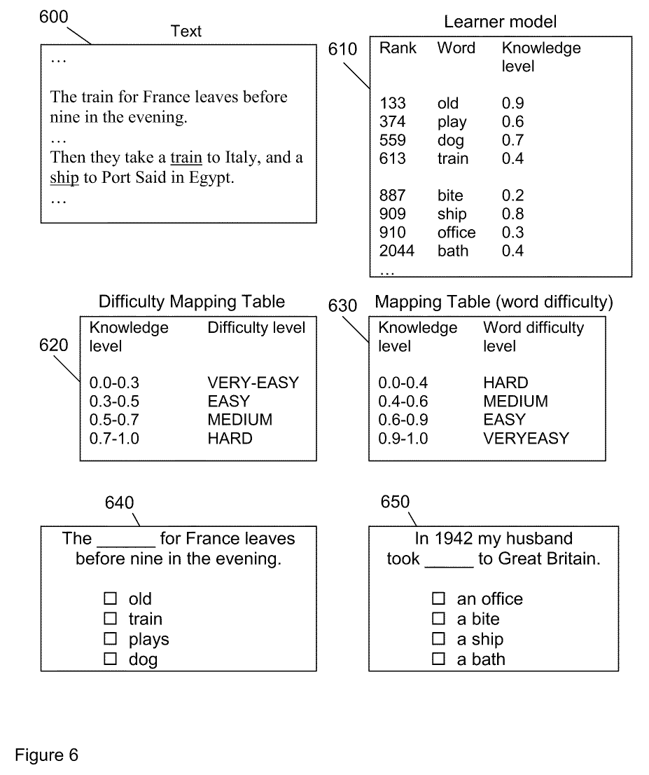

Step 320 then maps from the learner's knowledge level of the target learning item to a difficulty level. Any particular method of mapping can be used. In the preferred embodiment a difficulty mapping table is employed to map knowledge-level ranges to discrete difficulty values. FIG. 6 shows a difficulty mapping table 620, in which greater knowledge maps to greater required exercise difficulty. For example, a knowledge level between 0.3-0.5 maps to an “EASY” difficulty level. Alternative methods include, but are not limited to, setting the difficulty level to the knowledge level; using a continuous function, f, of knowledge level, diff-level=f(knowledge-level), where such a function could be learned over successive interactions using a machine-learning approach or using Computer Adaptive Testing; using, in addition or on its own, familiarity of a word; allowing the learner or teacher or other entity to influence the mapping (e.g., a learner may choose a more difficult or more easy experience, or a teacher may want to encourage a learner to try more difficult exercises). These rules and tables are provided as examples only, since the actual rules used in a system are calibrated through empirical research and/or a machine learning algorithm.

For example, consider the learner model 610 and the difficulty mapping table 620 shown in FIG. 6. If the target learning item is “train” then the learner's current knowledge level is seen to be 0.4, and the resulting difficulty level is “EASY” since 0.4 is in the range 0.3-0.5 in the mapping table 620.

Step 330 retrieves an exercise pattern from the exercise pattern database that corresponds to the predetermined exercise type. Each exercise type can correspond to zero or more exercise patterns. If zero, then no exercise of this type can be generated. If more than one, then it selects one pattern using any of a variety of known techniques the particulars of which are outside the scope of this embodiment. As a particular example, one pattern may be selected randomly from among a plurality of exercise patterns.

Step 340 generates the stem of the learning exercise, if the exercise pattern requires a stem. Any particular method can be used to generate the stem. Many methods are known in the art. In one example, to create a multiple-choice exercise to test if a student knows the meaning of word, the stem is the dictionary definition of the target word, which can be retrieved from the learning item information database 155. In a second example, the stem can ask the question “What does <target item> mean?” or “Select the picture of a <target item>.” In a third example the target item and a definition can be combined in the stem to create a true/false question. In a fourth example, a fill-in-the-blank question can be created by first selecting a sentence from the reading text (by consulting the text analyzer 140) or another source (such as the learning item information database 155) that contains the target learning item. The target learning item is replaced by a blank, thus asking the learner to fill in the blank with the right word. In a fifth example, a comprehension exercise can be generated by selecting a sentence from the reading text or another source that contains the target word and restructuring the sentence into a question (for example, the sentence “The earth revolves around the sun” can be restructured as “What does the earth revolve around?” for the target item “earth” or “sun”).

Step 340 can, in some cases, control the difficulty of the generated exercise by selecting the stem in dependence on the selected difficulty level (step 320) and on the learner model 130. For example, in the case of exercises that use a sentence (whether it is from text the user is reading, another source, or a definition text) as stem, the difficulty of the selected sentence can be controlled in at least two ways. First, a learner-specific difficulty level or readability level can be assigned to a sentence using, in part, the learner's knowledge level of each individual word in the sentence. One method is to find the average knowledge level of the words in the sentence, and map this to a sentence difficulty level. A mapping table 630 shown in FIG. 6 which is similar to, but a reversal of, the difficulty mapping table 620 can be used in which greater knowledge maps to easier words and sentences. Alternatively, a continuous function, g, such that word-difficulty-level=g(knowledge-level), can be averaged over all words in the sentence. A sentence with the same difficulty level (or nearly the same) as the selected difficulty level of step 320 can be used. Second, the sentence can be chosen based on the learner's familiarity with the sentence or words in it. If the difficulty level is “VERY-EASY”, then the current sentence can be used. If the difficulty level is “EASY”, then a previous sentence in the same text can be used. If the difficulty level is “MEDIUM” then a sentence from a previously read text can be used. If the difficulty level is “HARD” then an unknown sentence can be used. This step consults the text analysis generated by the text analyzer 140. These rules and tables are provided as examples only, since the actual rules used in a system are calibrated through empirical research and/or a machine learning algorithm.

Step 345 generates the correct answer to the exercise, if the exercise pattern requires answer options. In many cases, the correct answer is simply the target item itself. In other cases, it can be information about the word, for example, it's meaning, pronunciation, part of speech, an image, and so on, depending on the exercise type. This information can be retrieved from the learning item information database 155. Step 350 generates the distractors of the learning exercise, if the exercise pattern requires distractors. As with the stem any particular method can be used, depending on the exercise pattern. Many methods are known in the art. In one example, to create a multiple-choice exercise to test if a student knows the meaning of word, the distractors are other words. In a second example, when the stem asks the question “What does <target item>mean?” or “Select a picture of a <target item>” the distractors are definitions or pictures of words, which can be retrieved from the learning item information database 155. In a third example, a fill-in-the-blank question will have words as distractors that can be chosen to fill in the blank. In a fourth example, a comprehension exercise will have as distractors potential, but incorrect, answers to the comprehension exercise. The learning item information database 155 can be used to retrieve such potential answers in relation to the target learning item.

Step 350 can control the difficulty of the generated exercise by selecting the distractors in dependence on the selected difficulty level (step 320) and on the learner model 130. For example, in the case of exercises that use a sentence (e.g., a dictionary definition) in generating the distractors, the difficulty level of the sentence can be taken into account as in step 340. In the case of exercises that use words as distractors, the words can be selected to be at the right difficulty level. For example, for each potential distractor word, its word difficulty level can be computed, as described in step 340, and the words with the closest word difficulty level to the selected exercise difficulty level can be chosen. Alternatively, distractors can be chosen based on the learner's familiarity with the words. If the selected exercise difficulty level is low then more familiar can be chosen; if high, the less familiar words.

The known art includes many methods that control difficulty independently of a learner model, such as selecting distractors based on similarity to the correct answer (greater similarity leads to greater difficulty), or proxies of familiarity such as the frequency of the word over texts of the language. Those skilled in the art will appreciate that any of these methods for controlling the intrinsic difficulty of an exercise can be combined with the above methods or other methods of using a learner model.

Step 360 combines the generated stem and distractors into an exercise using the exercise pattern retrieved in step 330. The exercise can be formatted in any suitable format, for example text, XML, HTML, Flash, and so on.

Step 370 provides the generated exercise to the exercise viewing interface 110.

The exercise generation process will now be illustrated by means of an example.

FIG. 6 shows an example of a text reading interface 600 containing a portion of text of a book. If the user selects the word “train”, then the target learning item is determined to be “train”. The learner model 610 is consulted to find out that the learner's knowledge level of “train” is 0.4. The difficulty mapping table 620 is consulted to select the exercise difficulty level: it is “EASY” since 0.4 in is the range 0.3-0.5.

Assuming the exercise type is predetermined to be a fill-in-the-blank exercise, a suitable pattern is selected. An “EASY” difficulty level causes a recently read sentence from the text in interface 600 to be used, in this case, “The train for France leaves before nine in the evening.” The word “train” is replaced with a blank to generate the stem.

To select distractors, the learner model 610 is again consulted. Since the selected exercise difficulty level is “EASY”, then words with an “EASY” word difficulty level are chosen. Using the mapping table 630, the system finds that the words “old”, “play”, and “dog” are “EASY” since they have knowledge levels in the range 0.6-0.9. Additionally, in this example, an “EASY” difficulty level causes the distractor words to be chosen to have a different part of speech (“plays”, “old”) or different morphological inflections (“dogs” in plural) than the right answer, by consulting the learning item information database 155. The stem, correct answer, and distractors are combined into the exercise 640.

Similarly, if the learner selects the word “ship”, then the learner's knowledge level is seen to be 0.8. The exercise difficulty level “HARD” is selected using mapping table 620. To generate a “HARD” exercise, a sentence stem is chosen that comes from a different, but recent, text that the learner has read, in this case “In 1942 my husband took a ship to Great Britain”. “HARD” distractor words are chosen such that the knowledge level of the words is in the range 0.0-0.4, according to mapping table 630. Additionally, words are chosen that fit the paradigm “took a/an ( )” since they are similar to the right answer. The stem, correct answer, and distractors are combined into the exercise 650.

Several variations of the preferred embodiment are permitted.

In one variation of the preferred embodiment, the subject to be learned is not language per se. The textual material is for example a textbook or an encyclopaedia entry about a subject area to be learned such as physics, geography, or history. This embodiment could be integrated with any educational system that uses text in any form, such as written, audio, or video. The textual material may be in the learner's first language. The learner model 130 stores an estimate of the degree of mastery of each concept in a set of concepts associated with the subject area. The text analyzer 140 performs a linguistic analysis of the text in order to link words and phrases to concepts in the learner model. The exercise element generator 170 generates elements, such as distractors, that are associated with the subject to be learned. The learning item information database 155 contains subject area information. For example, instead of words as distractors, subject area concepts may be used. Or, instead of word definitions, short explanations, diagrams, or videos of the concepts may be used. The other components in this variation operate in a manner similar to the preferred embodiment.

In another variation of the preferred embodiment, learning exercises are generated in bulk after a user has finished a reading session using the text-reading interface 100, or indeed at any time selected by the user or the system. In this embodiment a set of learning exercises can be provided as a review of recently read language or subject material, or as a diagnostic device of the user's current strengths and weaknesses. In this embodiment, exercise generation (component 120) is performed in a loop using a list of learning items provided by the educational system or by the user. Step 300 selects as target learning item the next learning item from the list in each pass of the loop.

In another variation of the preferred embodiment, the exercise type itself and/or the exercise pattern can be selected by the exercise generator 120 in dependence on the learner model 130 and other information. In this embodiment, the learner model would store information about the learner-specific difficulty of different exercise types. For example, a particular learner might find exercises that use dictionary definitions to be easy, whereas a different learner may find such exercises difficult. In this embodiment, the exercise generator would include an exercise type selector, which would consult the learner model to determine an exercise type at an appropriate level of difficulty, in a manner similar to selecting exercise elements.

In another variation of the preferred embodiment, an external source can influence the difficulty level selector. For instance, a user or a teacher may wish to explicitly select a desired level of difficulty. In this embodiment, the exercise generator 120 would also take as input the desired difficulty level.

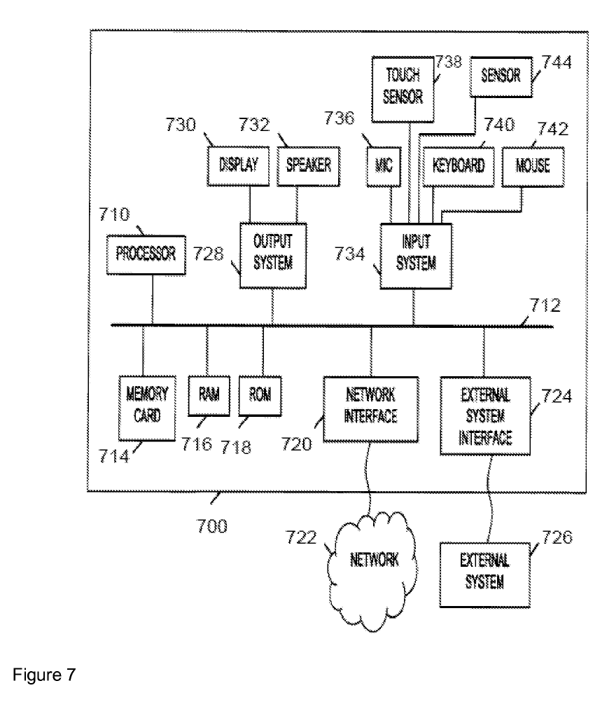

FIG. 7 is a block diagram of a computer system 700 suitable for practicing the invention as described herein. Those skilled in the art will appreciate that the system depicted in FIG. 7 is meant for illustrative purposes only and that other system configurations are suitable including personal computer systems, portable computer systems, and distributed computer systems. Such systems may utilize any of a variety of combinations of hardware, software and/or firmware. In the exemplary embodiment, the computer system 700 includes a processor 710, memory card 714, random-access memory (RAM) 716 and read-only memory (ROM) 718, for example. The computer system 700 also includes an output system 728 and an input system 734. Output devices include a display 730 and a speaker 732 for example. Input devices include a microphone 736, a touch sensor 738, a keyboard 740, a mouse 742 and other inputs sensors 744, for example. The system 700 may also include a network interface 720 that interfaces with an external computer network 722 using wired or wireless technologies. The system 700 also may include an external system interface 724 that interfaces with an external system 726. A system bus 712 interconnects all the components.

Those skilled in the art will appreciate that the educational system 100 as described above with reference to FIGS. 1-6 may be implemented within the computer system 700. The system 700 includes a computer program stored in a computer-readable storage medium which, when executed by the processor 710, causes the computer system 700 to function in the manner described herein with reference to FIGS. 1-6. The computer-readable storage medium may be part of, for example, the memory card 714, RAM 716, ROM 718, or any other known storage medium. Examples of such storage mediums include magnetic disk drives, optical storage mediums, volatile memory, non-volatile memory, etc. Those having ordinary skill in computer programming will be enabled based on the disclosure herein to provide specific computer executable code causing the processor 710 and remaining elements of the system 700 to execute and carry out the functions described herein. Such executable code may be provided using any of a variety of conventional programming languages and techniques without undue effort. Consequently, additional detail regarding the specific computer code has been omitted for sake of brevity.

The processor 710 may be any of a variety of different type processors or controllers. For example, the processor 710 may include any of a variety of commercially-available Intel® or AMD® processors for use in personal computers, network servers, etc. The display 730 may be any type of conventional display including, for example, a flat panel display of the LCD or plasma variety, a CRT based display, etc. As described herein, the text reading interface 100 and exercise viewing interface 110 are visually presented to the learner via the display 730. The learner may enter user controls and information via the text reading interface 100 and exercise viewing interface 110 using the keyboard 740, mouse 742, touch sensor 738, microphone 736, or other type of input device using known user interface techniques.

The learner model 130 and text analyzer 140, together with the difficulty level selector 160, exercise element generator 170 and exercise element combiner 180 (more generally the exercise generator 120), may each be implemented within the system 700 by the processor 710 executing the stored computer program so as to carry out the respective functions as described herein. The exercise pattern database 150 and learning item information database 155 include data stored within memory such as RAM 716.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A computer-implemented method for automatically generating learning exercises, comprising:
determining a target learning item in response to an event;
obtaining a knowledge level of a learner in relation to the target learning item based on a model of the learner as produced by an automated learner model;
associating a level of difficulty with the obtained knowledge level of the learner;
retrieving a learning exercise pattern from an exercise pattern database;
automatically generating a learning exercise relating to the retrieved learning exercise pattern based on the model of the learner and the associated level of difficulty; and
presenting the learning exercise to the learner via an exercise interface.

2. The method of claim 1, wherein the generating of the learning exercise includes generating one or more distractors.

3. The method of claim 2, wherein the one or more distractors are generated based on at least one of the model of the learner and the associated level of difficulty.

4. The method of claim 2, wherein the one or more distractors are retrieved from a learning item information database.

5. The method of claim 1, wherein the learning exercise pattern includes a stem.

6. The method of claim 5, wherein the stem is selected based on at least one of the model of the learner and the associated level of difficulty.

7. The method of claim 1, wherein the state of the learner model changes over time to reflect a current knowledge level of the learner.

8. The method of claim 1, wherein the target learning item is determined based on a selection of a word or group of words among text displayed on a user interface, and the knowledge level of the learner is determined by the automated learner model based on at least one of the learner's displayed mastery or familiarity with the word or group of words.

9. The method of claim 8, wherein the learning exercise is generated based in part on a linguistic analysis of the selected word or group of words.

10. The method of claim 1, wherein the exercise pattern database includes learning exercise patterns for a plurality of learning exercise types.

11. The method of claim 10, wherein the plurality of learning exercise types include at least one of multiple choice questions, true/false questions, matching questions, fill-in-the-blank questions, open-ended questions or comprehension questions.

12. The method of claim 1, wherein the learning exercise pattern is retrieved based on the associated level of difficulty.

13. A computer-implemented apparatus for automatically generating learning exercises, comprising:
a section for determining a target learning item in response to an event;
a section for obtaining a knowledge level of a learner in relation to the target learning item based on a model of the learner as produced by an automated learner model;
a section for associating a level of difficulty with the obtained knowledge level of the learner;
a section for retrieving a learning exercise pattern from an exercise pattern database;
a section for automatically generating a learning exercise relating to the retrieved learning exercise pattern based on the model of the learner and the associated level of difficulty; and
a section for presenting the learning exercise to the learner via an exercise interface.

14. The apparatus of claim 13, wherein the section for automatically generating is operative to generate one or more distractors.

15. The apparatus of claim 14, wherein the one or more distractors are generated based on at least one of the model of the learner and the associated level of difficulty.

16. The apparatus of claim 14, wherein the one or more distractors are retrieved from a learning item information database.

17. The apparatus of claim 13, wherein the learning exercise pattern includes a stem.

18. The method of claim 17, wherein the stem is selected based on at least one of the model of the learner and the associated level of difficulty.

19. The apparatus of claim 13, wherein the state of the learner model changes over time to reflect a current knowledge level of the learner.

20. The apparatus of claim 13, comprising a user interface and wherein the target learning item is determined based on a selection of a word or group of words among text displayed on the user interface, and the knowledge level of the learner is determined by the automated learner model based on at least one of the learner's displayed mastery or familiarity with the word or group of words.

21. The apparatus of claim 20, wherein the learning exercise is generated based in part on a linguistic analysis of the selected word or group of words.

22. The apparatus of claim 13, wherein the exercise pattern database includes learning exercise patterns for a plurality of learning exercise types.

23. The apparatus of claim 22, wherein the plurality of learning exercise types include at least one of multiple choice questions, true/false questions, matching questions, fill-in-the-blank questions, open-ended questions or comprehension questions.

24. The method of claim 13, wherein the learning exercise pattern is retrieved based on the associated level of difficulty.

25. A computer program stored on a computer-readable medium which, when executed by a computer, causes a computer to carry out the functions of:
determining a target learning item in response to an event;
obtaining a knowledge level of a learner in relation to the target learning item based on a model of the learner as produced by an automated learner model;
associating a level of difficulty with the obtained knowledge level of the learner;
retrieving a learning exercise pattern from an exercise pattern database;
automatically generating a learning exercise relating to the retrieved learning exercise pattern based on the model of the learner and the associated level of difficulty; and
presenting the learning exercise to the learner via an exercise interface.
